(19) United States
(12) Patent Application Publication
(10) Pub. No.: US 2017/0279860 A1
(43) Pub. Date: Sep. 28, 2017

(54) WEB COLLABORATION PRESENTER SHARING STATUS INDICATOR

(71) Applicant: Avaya Inc., Santa Clara, CA (US)

(72) Inventors: Ruby Agarwal, Lewisville, TX (US); Jeffrey Middleton, Richardson, TX (US)

(21) Appl. No.: 15/080,063

(22) Filed: Mar. 24, 2016

(51) Int. Cl. H04L 29/06; H04L 29/08; H04L 5/00

(52) U.S. Cl. CPC H04L 65/403; H04L 65/1066; H04L 5/0055; H04L 67/1095

(57) ABSTRACT

Methods and systems are provided for automatically determining whether participant devices in a collaborative communication session are synchronized with content shared by a presenting device. The methods and systems present an indication to a presenting device regarding a status of each participant device. The indication may include an interactive display configured to render an image, or images, representing the content one or more participant devices have received according to a state of synchronization of the participant devices in the communication session.

### FIELD

The present disclosure is generally directed to multi-party communications, in particular, toward conferences established between communication devices of users.

### BACKGROUND

Conferencing, and in particular web-conferencing, includes a range of communication services. These communication services can include, meetings, seminars, educational broadcasts, collaborative communication sessions, and/or other communications that are established between communication devices across a network. Information shared during typical collaborative communication sessions may include video, audio, multimedia, presentations, or other digital content. Effectively managing the pace of a presentation or web-based collaboration depends on a number of factors. When information is shared in a presentation the difficulty associated with effectively managing pace increases dramatically.

### BRIEF DESCRIPTION OF THE DRAWINGS

FIG. 1 depicts a block diagram of a communication system in accordance with at least some embodiments of the present disclosure;

FIG. 2 is a block diagram depicting components of a server used in a communication system in accordance with at least some embodiments of the present disclosure;

FIG. 3 is a block diagram depicting a collaborative communication system user interface in accordance with at least some embodiments of the present disclosure;

FIG. 4A is a block diagram depicting a first interactive collaborative communication session participant status interface presentation in accordance with at least some embodiments of the present disclosure;

FIG. 4B is a block diagram depicting a second interactive collaborative communication session participant status interface presentation in accordance with at least some embodiments of the present disclosure;

FIG. 5 is a block diagram depicting a collaborative communication session participant device status data structure used in accordance with at least some embodiments of the present disclosure;

FIG. 6 is a flow diagram depicting a first method of sharing participant device status in a collaborative communication session in accordance with at least some embodiments of the present disclosure;

FIG. 7 is a flow diagram depicting a second method of sharing participant device status in a collaborative communication session in accordance with at least some embodiments of the present disclosure; and

FIG. 8 is a flow diagram depicting a third method of sharing participant device status in a collaborative communication session in accordance with at least some embodiments of the present disclosure.

### DETAILED DESCRIPTION

Embodiments of the present disclosure will be described in connection with the execution of a communication management system. The communication management system may be configured to manage communications between one or more communication devices. In some cases, the system may establish collaborative communication sessions, multi-party meetings, presentations, or conferences, between multiple communication devices across a communication network. The collaborative communication session may include presentations and one or more of a presenter, a moderator, a participant, or presentation content. Additionally or alternatively, the collaborative communication sessions may include information relating to the communication session itself, participants and/or devices involved, participants invited, relationships of participants to one another, relationships of participants in an organization, topics scheduled, topics discussed, action items, media uploaded, and/or other information.

When a presenter is sharing content in a collaborative communication session, there can exist a delay in the transmission of the shared content/data to one or more participant devices in the communication session. Additionally, there may be a question as to whether or not the participant device clients switched into sharing mode. Also, there may be a question as to whether or not the participant devices are receiving what the presenter is sending concurrently. If there is a loss of synchronization, the loss may be exaggerated if the presentation is being recorded at one or more locations.

For example, the presenter may be on a subsequent slide or even two or three slides beyond, and some participant devices may not yet have switched to the new slide view because of differing transmission rates or bandwidth capabilities. The discontinuity may lead to delays, complaining, etc.

It is with respect to the above issues and other problems that the embodiments presented herein were contemplated. Among other things, the present disclosure solves these and other issues by providing a presenter sharing status indicator. The presenter sharing status indicator is operable to provide a visual indication of when content being shared is, or is no longer, synchronized.

In some embodiments, the presenter sharing status indicator may be operable to alert a presenter when content shared in a collaborative communication session gets out of sync. The indicator may be configured as a visual indicator such as text, an icon, an image, etc., and/or combinations thereof. The visual indicator or icon may provide a status associated with a participant device such as updating, updated, in sync, delayed, and waiting, and may optionally or additionally use color changes and/or other visual indicators to give status. The indicator may also include a mouse-over display, pop-up window, or thumbnail that allows the presenter or a moderator to know exactly what a participant associated with each participant device is seeing in real-time.

It is an aspect of the present disclosure that embodiments of the sharing status indicator described herein may provide information indicative of quality of service (QoS) issues in a network. In response to determining synchronization issues exist in a network, the communication management system/server may perform alternate call routing or bandwidth reallocation for certain calls (e.g., routing the calls to other web servers on the network, providing a list of preferred web servers to go to when there are problems, and/or performing other QoS improvement techniques). In one embodiment, the adjustments of bandwidth use, or routing, may apply to WebRTC connections. Additionally or alternatively, the adjustments of bandwidth use, or routing, may apply to HTTP or Web Socket connection to a web server. In one example, collaboration data may be over HTTP/Web Socket while audio/video may use WebRTC for browser-based clients.

As can be appreciated, the present disclosure can provide indications when there are delays in a network. For instance, the presenter sharing status indicator as described may be operable to give a visual indication of when each participant is in or not in synchronization with displayed content. In one embodiment, the idea may be expanded to and tied into a system for tracking, troubleshooting, and solving issues by modifying bandwidth and transmission rates, etc.

In some embodiments, displaying all participant devices may be one way to see status. However, in cases where there are more than can easily be seen (e.g., rendered to a display associated with a communication device, etc.) or in a case where it might be a helpful addition, an overall or aggregate view of state should be displayed. This can be extended to pagination (e.g., dividing a document into discrete pages) and/or other digital display options (e.g., different than just viewing).

In one embodiment, participant roles may be important to presentation state, pace, and/or synchronization. For example, if the CEO of a company is having issues (e.g., experiencing delays, synchronization issues, etc.) but the VPs are synchronized with the presentation, the status indicator may be adjusted accordingly. Continuing this example, the CEO role may be considered more important than a company VP, and as such, the presenter may be notified to slow the presentation pace to accommodate the CEO (e.g., having the important role designation, etc.). The context (e.g., organizational hierarchy/structure, position, function, title, and/or other role information) may be retrieved from conference information provided by a registering participant device, or may be retrieved from some memory associated with the communication management system/server.

As provided herein, the user interfaces or displays provided to a communication device associated with a presenter may be provided to one or more other devices. For instance, these interfaces and/or displays may be provided to a moderator, as well as the presenter, if the moderator and presenter are different people or are accessing the collaborative meeting using different communication devices.

Additionally or alternatively, the present disclosure may be configured to keep track of what display/object is accessible to one or more of the communication devices in the collaborative meeting. For example, a presentation (e.g., multimedia, documents, slides, etc.) may be downloaded and/or viewed by participant devices separately from a display of the presentation by a presenter. In some embodiments, the communication management server may show/give a visual indication to the presenter when participants are skipping ahead, or lagging behind, in the downloaded or separately viewed presentations. This visual indication may serve as an indicator to the presenter to alter the pace of the presentation. For instance, when a certain number of participant devices are determined to be skipping ahead in the presentation, the visual indicator may indicate that the presenter should speed up the current pace of the presentation. Additionally or alternatively, when a certain number of participant devices are determined to be lagging behind in the presentation, the visual indicator may indicate that the presenter should slow the current pace of the presentation.

Embodiments include a communication server, comprising: a server, comprising: a microprocessor; and a computer readable medium coupled to the microprocessor and comprising instructions stored thereon that cause the microprocessor to: produce instructions that render a participant device status window in a user interface, the participant device status window including a presentation synchronization status for one or more participant devices in a collaborative communication session; send a presentation frame to the one or more participant devices in the collaborative communication session when a presentation content associated with the collaborative communication session changes; determine whether the one or more participant devices received the presentation frame sent; update the presentation synchronization status for the one or more participant devices based on the determination of whether the one or more participant devices received the presentation frame sent; and present the presentation synchronization status for the one or more participant devices to a presenter device in the collaborative communication session.

Aspects of the above communication server include a network interface that enables the microprocessor to present the presentation synchronization status for the one or more participant devices to the presenter device in the collaborative communication session. Aspects of the above communication server include wherein the presentation synchronization status comprises a synchronization identifier and a representative image, the synchronization identifier indicating a synchronization type for the one or more participant devices and the representative image corresponding to an image of a last presentation frame received by the one or more participant devices. Aspects of the above communication server include wherein the presentation synchronization status for each participant device of the one or more participant devices in the participant device status window is configured to receive a selection input, and wherein the selection input causes a thumbnail of the image of the last presentation frame received by the one or more participant devices to be rendered by a display of the presenter device. Aspects of the above communication server include, prior to causing the microprocessor to send the presentation frame to the one or more participant devices in the collaborative communication session, the microprocessor is caused to receive presentation content information from the presenter device; and convert the received presentation content into the presentation frame. Aspects of the above communication server include wherein the presentation frame is sent with a receipt acknowledgement request, and wherein causing the microprocessor to determine whether the one or more participant devices received the presentation frame sent further causes the microprocessor to determine whether a receipt acknowledgement is received from the one or more participant devices. Aspects of the above communication server include wherein causing the microprocessor to update the presentation synchronization status further causes the microprocessor to determine whether the synchronization identifier should be updated, wherein the synchronization identifier should be updated only when the one or more participant devices did not receive the presentation frame sent; and determine whether the representative image should be updated, wherein the representative image should be updated only when the one or more participant devices received the presentation frame sent. Aspects of the above communication server include wherein the presentation frame is sent to the one or more participant devices using a reliable data transfer protocol, the reliable data transfer protocol requiring the one or more participant devices to send an acknowledgement signal when the presentation frame is received by the one or more participant devices. Aspects of the above communication server include wherein the collaborative communication session is hosted by the server.

Embodiments include a method, comprising: generating, via a processor, a participant device status window for rendering in a user interface, the participant device status window including a presentation synchronization status for one or more participant devices in a collaborative communication session; sending, via the processor, a presentation frame to the one or more participant devices in the collaborative communication session when a presentation content associated with the collaborative communication session changes; determining, via the processor, whether the one or more participant devices received the presentation frame sent; and updating, via the processor, the presentation synchronization status for the one or more participant devices based on whether the one or more participant devices received the presentation frame sent.

Aspects of the above method include wherein the presentation synchronization status comprises a synchronization identifier and a representative image, the synchronization identifier indicating a synchronization type for the one or more participant devices and the representative image corresponding to an image of a last presentation frame received by the one or more participant devices. Aspects of the above method include wherein the presentation synchronization status for each participant device of the one or more participant devices for rendering in the participant device status window is configured to receive a selection input, and wherein the selection input causes a thumbnail of the image of the last presentation frame received by the one or more participant devices to be rendered by a display device. Aspects of the above method include wherein prior to causing the microprocessor to send the presentation frame to the one or more participant devices in the collaborative communication session, the method further comprises: receiving, via the processor, presentation content information from a presenter device in the collaborative communication session; and converting, via the processor, the received presentation content into the presentation frame. Aspects of the above method include wherein the presentation frame is sent with a receipt acknowledgement request, and wherein determining whether the one or more participant devices received the presentation frame sent further comprises determining whether a receipt acknowledgement is received from the one or more participant devices. Aspects of the above method include wherein updating the presentation synchronization status further comprises: determining, via the processor, whether the synchronization identifier should be updated, wherein the synchronization identifier should be updated only when the one or more participant devices did not receive the presentation frame sent; and determining, via the processor, whether the representative image should be updated, wherein the representative image should be updated only when the one or more participant devices received the presentation frame sent. Aspects of the above method include wherein the presentation frame is sent to the one or more participant devices using a reliable data transfer protocol, the reliable data transfer protocol requiring the one or more participant devices to send an acknowledgement signal when the presentation frame is received by the one or more participant devices. Aspects of the above method include presenting, via the processor, the presentation synchronization status for the one or more participant devices to a presenter device in the collaborative communication session. Aspects of the above method include wherein the presentation synchronization status comprises presentation pace feedback information configured to be rendered as an indication that the presenter device is moving at least one of too quickly, too slowly, or sufficiently through a presentation in the collaborative communication session.

Embodiments include a conference server, comprising: a processor; and a computer-readable medium, coupled with the processor, the computer-readable medium comprising instruction sets that are executable by the processor, wherein the instruction sets cause the processor to: receive a presentation frame from a presenter device in a collaborative communication session with one or more participant devices when a presentation content associated with the collaborative communication session changes; send the presentation frame to the one or more participant devices in the collaborative communication session; receive an acknowledgement message from each participant device in the one or more participant devices that received the presentation frame sent; and determine a presentation synchronization status for the one or more participant devices in the collaborative communication session identifying a state of synchronization for each of the one or more participant devices in the collaborative communication session, wherein a participant device in the one or more participant devices is identified as being out of synchronization when no acknowledgement message is received from the participant device.

Aspects of the above conference server include wherein the presentation synchronization status is included in a participant device status window presented to the presenter device in the collaborative communication session. Aspects of the above conference server include wherein the presentation synchronization status comprises a synchronization identifier and a representative image, the synchronization identifier indicating a synchronization type for each of the one or more participant devices and the representative image corresponding to an image of a last presentation frame received by each of the one or more participant devices, wherein the presentation synchronization status for each of the one or more participant devices in the participant device status window is configured to receive a selection input, and wherein the selection input causes a thumbnail of the image of the last presentation frame received by the one or more participant devices to be rendered by a display of the presenter device.

Embodiments include a server, comprising: a processor; and a computer-readable medium, coupled with the processor, the computer-readable medium comprising instruction sets that are executable by the processor, wherein the instruction sets cause the processor to: produce instructions that render a participant device status window in a user interface, the participant device status window including a presentation synchronization status for one or more participant devices in a collaborative communication session; send a presentation frame to the one or more participant devices in the collaborative communication session when a presentation content associated with the collaborative communication session changes; determine whether the one or more participant devices received the presentation frame sent; and update the presentation synchronization status for the one or more participant devices based on whether a communication device of at least one participant received the presentation frame sent.

Aspects of the above server include wherein the participant device status window is presented to a presenter device in the collaborative communication session. Aspects of the above server include wherein the presentation synchronization status comprises a synchronization identifier and a representative image, the synchronization identifier indicating a synchronization type for the one or more participant devices and the representative image corresponding to an image of a last presentation frame received by the one or more participant devices, wherein the presentation synchronization status for each participant device of the one or more participant devices in the participant device status window is configured to receive a selection input, and wherein the selection input causes a thumbnail of the image of the last presentation frame received by the one or more participant devices to be rendered by a display device of the presenter device.

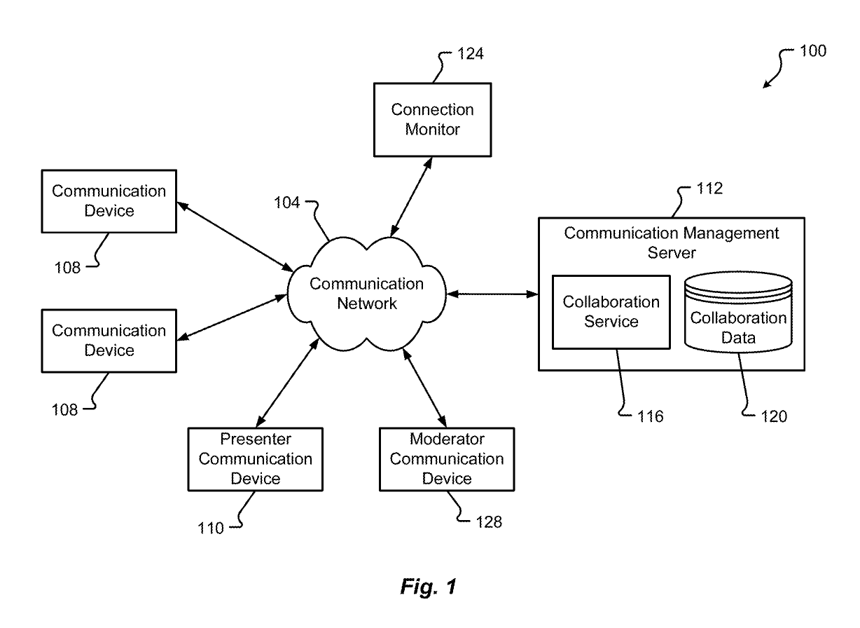

Referring to FIG. 1, a block diagram of a communication system 100 is shown in accordance with at least some embodiments of the present disclosure. The communication system 100 of FIG. 1 may be a distributed system and, in some embodiments, comprises a communication network 104 connecting communication devices 108, 110, 128 with a communication management server 112. The communication system 100 may include, but is not limited to, a connection monitor 124, a collaboration service 116, and collaboration data 120. In one embodiment, communication devices 108, 110, 128 may be communicatively connected to a collaboration service 116 of the communication management server 112. For example, the collaboration service 116 may provide collaborative communication sessions, multi-party calls, web-based conferencing, web-based seminar (“webinar”), and/or other audio/video communication services. In any event, the collaborative communication sessions can include two, three, four, or more communication devices 108, 110, 128 that access the collaboration service 116 via a communication network 104.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Voice over Internet Protocol (VoIP) network, a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. The communication network 104 may comprise a number of different communication media such as coaxial cable, copper cable/wire, fiber-optic cable, antennas for transmitting/receiving wireless messages, and combinations thereof.

The communication devices 108, 110, 128 may correspond to at least one of a smart phone, tablet, personal computer, and/or some other computing device. Each communication device 108, 110, 128 may be configured with an operating system (“OS”) and at least one communication application. The communication application may be configured to exchange communications between the communication device 108, 110, 128 and another entity (e.g., a communication management server 112, another communication device 108, 110, 128, etc.) across the communication network 104. Additionally or alternatively, communications may be sent and/or received via the communication device 108, 110, 128 as a telephone call, a packet or collection of packets (e.g., IP packets transmitted over an IP network), an email message, an instant message (“IM”), an SMS message, an MIMS message, a chat, and/or combinations thereof. In some embodiments, the communication device 108, 110, 128 may be associated with one or more users in the communication system 100. In one embodiment, a communication device 108, 110, 128 may switch from a participant device to a presenting device or a moderator device, and vice versa.

The communication management server 112 may include hardware and/or software resources that, among other things, provides the ability to hold multi-party calls, conference calls, and/or other collaborative communications. The communication management server 112 may include a conference service 112, conference data memory 120, a tag application module 124, and conference and tag information memory 128 to name a few.

In some embodiments, the collaboration service 116 may be included in the communication management server 112 and/or as a separate service or system of components apart from the communication management server 112 in the communication system 100. In any event, the collaboration service 116 provides conferencing resources that can allow two or more communication devices 108 to participate in a collaborative communication session or conference. One example of a collaborative communication session includes, but is not limited to, a web-conference session between two or more users/parties, webinars, collaborative meetings, and the like. Although some embodiments of the present disclosure are discussed in connection with collaborative communication sessions, embodiments of the present disclosure are not so limited. Specifically, the embodiments disclosed herein may be applied to one or more of audio, video, multimedia, conference calls, web-conferences, and the like.

In some embodiments, the collaboration service 116 can include one or more resources such as conference mixers and other conferencing infrastructure. As can be appreciated, the resources of the collaboration service 116 may depend on the type of collaborative communication session provided by the collaboration service 116. Among other things, the collaboration service 116 may be configured to provide conferencing of at least one media type between any number of participants. The conference mixer of the collaboration service 116 may be assigned to a particular collaborative communication session for a predetermined amount of time. In one embodiment, the conference mixer may be configured to negotiate codecs with each communication device 108, 110, 128 participating in a collaborative communication session. Additionally or alternatively, the conference mixer may be configured to receive inputs (at least including audio inputs) from each participating communication device 108, 110, 128 and mix the received inputs into a combined signal which can be monitored and/or analyzed by the communication management server 112.

The collaboration data memory 120 may include presentations, slides, documents, participant information, uploaded information, participant information, invitation information, and/or other information accessed by the collaboration service 116 and/or the communication management server 112. For instance, a meeting host may upload a presentation and/or other digital files to the collaboration data memory 120 of the server 116 prior to, or during, a meeting. Continuing this example, the host may access the one or more files contained in the memory 120 for presentation to an audio/video output of one or more communication devices 108, 110, 128 of other participants in the collaborative communication session.

In some embodiments, the communication management server 112 may include a connection monitor 124. The connection monitor 124 may analyze connection information associated with each communication device 108, 110, 128 registered with the communication management server 112. The connection information may include, but is in no way limited to, bandwidth, QoS, information upload rate, information download rate, ping statistics, reliability of a connection, “traceroute” or network transit delay information, etc., and/or combinations thereof. It is an aspect of the present disclosure that the connection monitor 124 may store connection information associated with one or more participant devices, presenter devices, and/or moderator devices (e.g., communication devices 108, 110, 128) at one or more times in the collaboration data memory 120 or some other memory in the communication system 100.

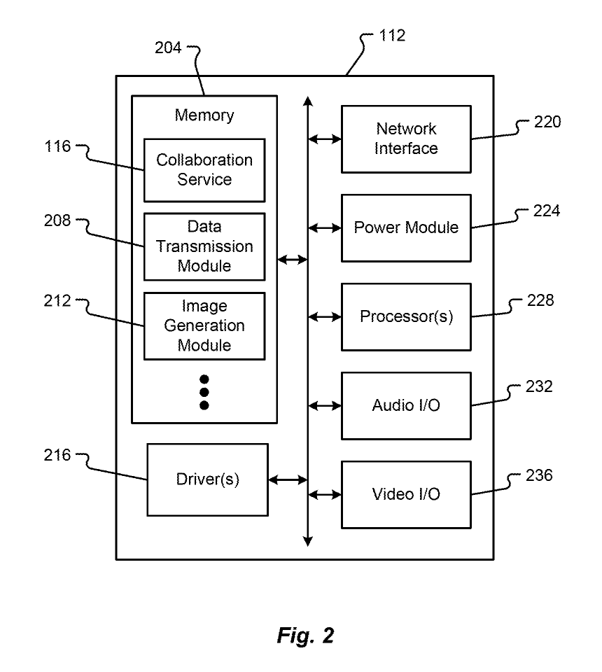

FIG. 2 is a block diagram depicting components of a communication management server 112 used in the communication system 100 in accordance with at least some embodiments of the present disclosure. The server 112 is shown to include a computer memory 204 that stores one or more instruction sets, applications, or modules, potentially in the form of a collaboration service 116, a data transmission module 208, and/or an image generation module 212. The communication management server 112 may be configured as a server, or part of a server, that includes any or all of the components of the communication system 100 depicted in FIG. 1. The communication management server 112 is also shown to include one or more drivers 216, a network interface 220, a power module 224, a processor 228, an audio input/output (“I/O”) 232, and a video I/O 236.

The memory 204 may correspond to any type of non-transitory computer-readable medium. In some embodiments, the memory 204 may comprise volatile or non-volatile memory and a controller for the same. Non-limiting examples of memory 204 that may be utilized in the tag management server 132 include RAM, ROM, buffer memory, flash memory, solid-state memory, or variants thereof. Any of these memory types may be considered non-transitory computer memory devices even though the data stored thereby can be changed one or more times.

The applications/instructions 116, 208, 212 may correspond to any type of computer-readable instructions or files storable in the memory 204. The data transmission module 208 may receive presentation information from a presenter communication device 110 representing data (e.g., presentation content, digital media, slides, etc.) to be shared with one or more participant, or communication, devices 108 in the communication system 100. Upon receiving the presentation information (e.g., from a presenter communication device 110, etc.), the data transmission module 208 may convert the presentation data into one or more “frames.” Each frame may represent content from a stream of images in the presentation. The images may be encoded in a particular format (e.g., JPEG, PNG, etc.), and when converted into frames, are sent across the communication network 104 via a reliable transfer protocol. For instance, a frame representing a particular slide may be sent across the communication network using the TCP/IP protocol. Continuing this example, the data transmission module 208 may send a frame to a receiving device (e.g., communication devices 108, 110, 128, etc.) requiring a positive acknowledgment by the receiving device (e.g., an ACK signal, etc.). If the acknowledgment signal is not received by the data transmission module 208, the data transmission module 208 may retransmit the frame until the acknowledgment signal is received. When the acknowledgment signal is received, the data transmission module 208 may proceed by transmitting a new frame (e.g., the subsequent frame, etc.) in the presentation to the receiving device. It is an aspect of the present disclosure that the data transmission module 208 may track (e.g., determine and store, etc.) the last successfully transmitted frame (e.g., where an ACK signal was received, etc.) for each communication device 108, 110, 128 participating in the collaborative communication system.

The image generation module 212 may be configured to generate an image based on information associated with a particular device 108, 110, 128 that is, or was, part of a collaborative communication session. The image may correspond to a video clip, a thumbnail, an icon, a representative image, or other image or group of images. The image may be associated with the frame that was last successfully transmitted to (and received by) the particular device 108, 110, 128. As can be appreciated, the image generation module 212 may communicate with the collaboration service 116, the data transmission module 208, and/or any data associated with one or more communication devices 108, 110, 128, transmitted frames, presentation information, and/or the like.

The driver(s) 216 may correspond to hardware, software, and/or controllers that provide specific instructions to hardware components of the communication management server 112, thereby facilitating their operation. For instance, the network interface 220, power module 224, audio I/O 232, video I/O 236, and/or memory 204 may each have a dedicated driver 216 that provides appropriate control signals to effect their operation. The driver(s) 216 may also comprise the software or logic circuits that ensure the various hardware components are controlled appropriately and in accordance with desired protocols. For instance, the driver 216 of the network interface 220 may be adapted to ensure that the network interface 220 follows the appropriate network communication protocols (e.g., TCP/IP (at one or more layers in the OSI model), TCP, UDP, RTP, GSM, LTE, Wi-Fi, etc.) such that the network interface 220 can exchange communications via the communication network 104. As can be appreciated, the driver(s) 216 may also be configured to control wired hardware components (e.g., a USB driver, an Ethernet driver, fiber optic communications, etc.).

The network interface 220 may comprise hardware that facilitates communications with other communication devices over the communication network 104. As mentioned above, the network interface 220 may include an Ethernet port, a Wi-Fi card, a Network Interface Card (NIC), a cellular interface (e.g., antenna, filters, and associated circuitry), or the like. The network interface 220 may be configured to facilitate a connection between the communication management server 112 and the communication network 104 and may further be configured to encode and decode communications (e.g., packets) according to a protocol utilized by the communication network 104.

The power module 224 may include a built-in power supply (e.g., battery) and/or a power converter that facilitates the conversion of externally-supplied AC power into DC power that is used to power the various components of the communication management server 112. In some embodiments, the power module 224 may also include some implementation of surge protection circuitry to protect the components of the communication management server 112, or other associated server, from power surges.

The processor 228 may correspond to one or many microprocessors that are contained within a common housing, circuit board, or blade with the memory 204. The processor 228 may be a multipurpose, programmable device that accepts digital data as input, processes the digital data according to instructions stored in its internal memory, and provides results as output. The processor 228 may implement sequential digital logic as it has internal memory. As with most microprocessors, the processor 228 may operate on numbers and symbols represented in the binary numeral system.

The audio I/O interface 232 can be included to receive and transmit audio information signals between the various components of the system 100. By way of example, the audio I/O interface 232 may comprise one or more of an associated amplifier and analog to digital converter. Alternatively or additionally, the audio I/O interface 232 may be configured to separate audio information from a media stream provided to, or received by, the communication management server 112. This information may be separated in real-time, or as the information is received by the communication management server 112.

The video I/O interface 236 can be included to receive and transmit video signals between the various components in the system 100. Optionally, the video I/O interface 236 can operate with compressed and uncompressed video signals. The video I/O interface 236 can support high data rates associated with image capture devices. Additionally or alternatively, the video I/O interface 236 may convert analog video signals to digital signals. Similar to the audio I/O interface 232, the video I/O interface 236 may be configured to separate video information from a media stream provided to, or received by, the communication management server 112.

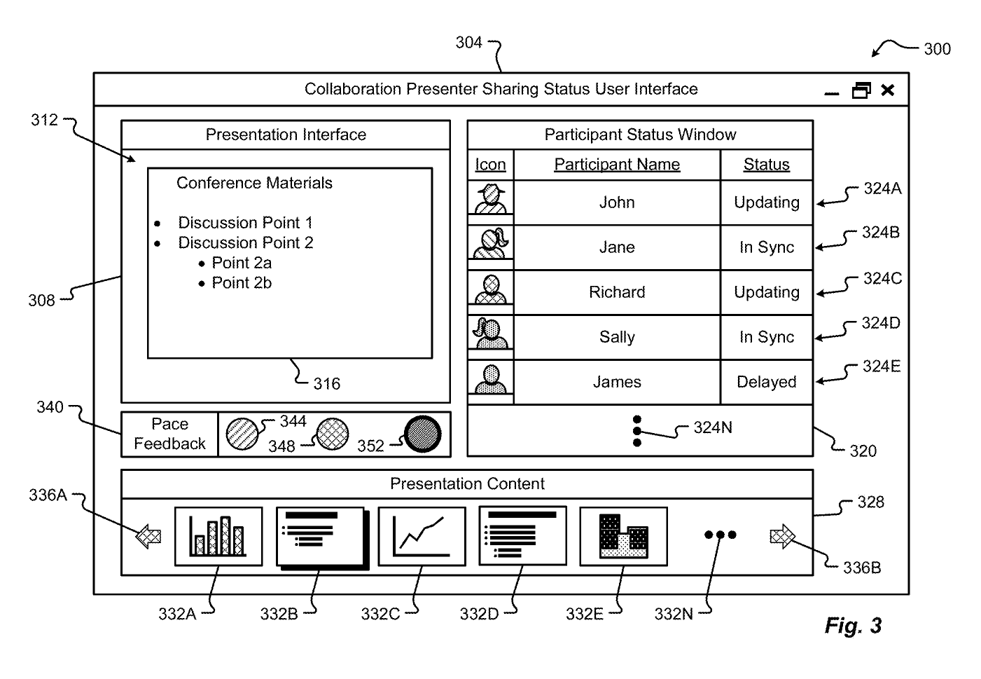

FIG. 3 is a block diagram depicting a collaborative communication system user interface 300 in accordance with at least some embodiments of the present disclosure. The user interface 300 may include a window 304 that can be presented to a display of a communication device 108, 110, 128 or server 112. The window 304 may include identification information, application controls, and at least one viewing area. The viewing area of the window 304 may be separated into a number of different areas 308, 320, 344. In particular, the window 304 may include a presentation interface area 308, a participant device status viewing area 320, a presentation content viewing area 328, and a presentation pace feedback viewing area 340.

The presentation interface area 308 may include a display area 312. The display area 312 may be configured to present information pertinent to the collaborative communication session, participants, files, documents, etc. The display area 312 may show recorded, live, or other presentations, slides, images, and/or video streams. As shown in FIG. 3, the display area 312 includes an image of a displayed presentation slide 316 (e.g., electronic presentation image, slide, digital image, etc.). In some embodiments, the display area 312 may show a presentation shared between one or more participants in a collaborative communication session or meeting. In one embodiment, a display of the particular information shown in the display area 312 may be selectively controlled by a presenter (e.g., via a presenter communication device 110, etc.), a participant (e.g., via a communication device 108, etc.), and/or a moderator (e.g., via a moderator communication device 128, etc.) in the communication session. In the case of certain presentations and/or conferences (e.g., interactive communications, webinars, buffered presentations, etc.), the presentation interface area 308 may include playback controls, audio controls, video controls, and/or other content controls.

The participant device status viewing area, or interface 320 may provide a user interface to at least one of view, order, rank, and/or expand details corresponding to participants communicatively connected to the collaborative communication session via one or more communication devices 108. In some embodiments, the participant device status viewing area 320 may dynamically and continually update a presentation viewing status associated with a particular participant's communication device 108, 110, 128. For example, as presentation information is shared by a presenter in the communication session, the presentation information is distributed to one or more devices communicatively connected to the communication management server 112. When a particular device acknowledges receipt of a particular frame associated with the presentation information, a status field in the participant device status viewing area 320 may be updated to reflect a status of the particular device. Continuing this example, when a particular communication device 108, 110, 128 is viewing the same content as is presented by a presenter (e.g., in the presentation interface area 308, etc.) the particular communication device 108, 110, 128 is “in sync” or synchronized with the presentation. When another communication device 108, 110, 128 is viewing the different content than that presented by a presenter (e.g., in the presentation interface area 308, etc.) the particular communication device 108, 110, 128 may be out of sync, updating, delayed, or not synchronized with the presentation. In any event, this information may be shown in the participant device status viewing area 320.

As illustrated in FIG. 3, the participant device status viewing area 320 is shown including a number of rows 324A-N. Each row 324A-N may correspond to a particular participant and/or participant device 108, 110, 128 that is communicatively connected to the communication management server 112. For instance, the first row 324A shows (from left to right) a user icon (e.g., symbol, video image, photograph, live video feed, and/or avatar, etc. associated with a first participant), an identification (e.g., participant name, title, etc.) of the first participant, and a presentation status indicator. Although shown as text, the status indicator may take a number of forms. For example, the status indicator may be represented as text, images, moving images, video, lights, colors, etc., and/or combinations thereof. It should be appreciated that the participant device status viewing area 320 or the rows 324A-N may include more or less information than is shown in FIG. 3.

The presentation content viewing area 328 may include a display area configured to present information pertinent to the presentation, files, documents, and/or other information shared during the collaborative communication session. In one embodiment, the presentation content viewing area 328 may include information associated with a presentation as the information is being presented (e.g., to the display area 312, etc.). As shown in FIG. 3, the presenter may navigate through a number of slides represented as thumbnails 332A-N in a presentation. The individual slides and thumbnails 332A-N may be manually selected by the presenter. When a particular slide 316 is displayed to the display area 312, the slide thumbnail 332B representing that slide is highlighted in the presentation content viewing area 328. In one embodiment, when a particular slide thumbnail 332A-N is selected, the corresponding slide will be displayed in the display area 312. In any event, a particular slide thumbnail (e.g., 332B) may be highlighted, or otherwise identified, as being displayed to the display area 312 (e.g., as slide 316). As shown in FIG. 3, this identification is shown by a dark shading, or shadow, behind the thumbnail image of slide thumbnail 332B.

In some cases, the slide thumbnails 332A-N may automatically index as one or more slides are selected. For instance, the slide deck represented by slide thumbnails 332A-N may move in a direction relative to a focus point, or a focus point (e.g., a focus that highlights a particular slide thumbnail) may be indexed in a direction relative to the user interface 300. In some embodiments, a presenter may navigate through one or more slide thumbnails 332A-N using direct selection of the slide thumbnails 332A-N in the presentation content viewing area 328 or via slide deck controls 336A, 336B. As can be appreciated, the first slide deck control 336A, when selected, may be configured to move a focus in a leftward direction or the slide deck in a rightward direction, or vice versa. Additionally or alternatively, the second slide deck control 336B, when selected, may be configured to move a focus in a rightward direction or the slide deck in a leftward direction, or vice versa.

The pace feedback indicator 340 may include information regarding a pace of the presentation that is based, at least partially, on a synchronization status of one or more participant communication devices 108 in the collaborative communication session. For instance, the pace feedback indicator 340 may include an indication of whether a particular participant device is delayed. In one embodiment, the pace feedback indicator 340 may include an notification configured to alert the presenter that an adjustment in pace is necessary based, at least in part, on the transmission of information to one or more of the participant communication devices 108. By way of example, the pace feedback indicator 340 may include a first indicator 344, a second indicator 348, and a third indicator 352. The first indicator 344, when highlighted (e.g., via illumination, action, flashing, color, etc.), may indicate that a presenter is presenting at a pace that is considered “too slow.” For instance, all of the participant communication devices 108 may be shown as “in sync” or, in an alternative embodiment, may be navigating ahead in a presentation. The second indicator 348, when highlighted (e.g., via illumination, action, flashing, color, etc.), may indicate that a presenter is presenting at a pace that is considered “just right.” In other words, all or most of the participant devices have an “in sync” status and are keeping up with the presentation. The third indicator 352, when highlighted (e.g., via illumination, action, flashing, color, etc.), may indicate that a presenter is presenting at a pace that is considered “too fast.” For instance, all of the participant communication devices 108 may be shown as “out of sync” or, in an alternative embodiment, may be navigating behind in a presentation. In some embodiments, the presenter may adjust a speed of presentation to adhere to the suggestion of the pace feedback indicator 340. In one embodiment, the presentation speed may be automatically adjusted by the communication management server 112 in response to receiving a particular pace feedback output. As shown in FIG. 3, the third indicator 352 is highlighted with a thick border surrounding the indicator 352.

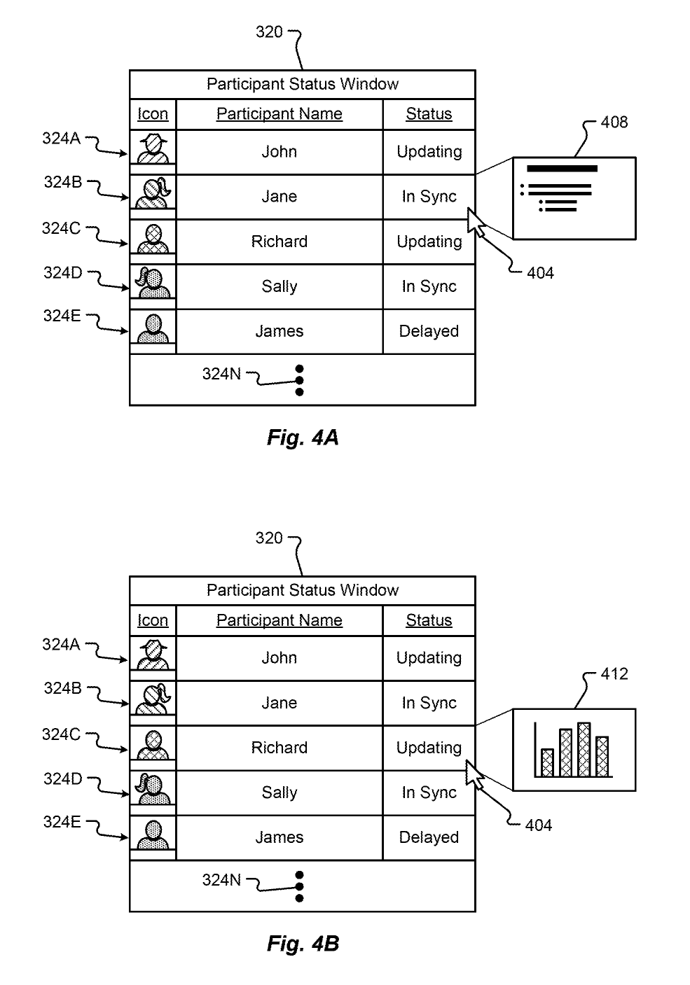

FIGS. 4A and 4B are a block diagrams depicting user interaction with an interactive collaborative communication session participant status interface 320 in accordance with at least some embodiments of the present disclosure. The interactive collaborative communication session participant status interface 320 and/or the components thereof may correspond to the participant status window/area and/or components shown and described in conjunction with FIG. 3. As illustrated in FIG. 4A a user interface element 404 (e.g., mouse cursor, etc.) is shown hovering over, or selecting, the status associated with the second row 324B participant device. In one embodiment, as a user (e.g., presenter, moderator, etc.) moves the interface element 404 over the status indication portion of a particular row 324A-N a pop-up window 408, or thumbnail image may display to an area of the user interface 300. In some embodiments, the user may be required to hover over the status indication portion for a specific period of time, or actively select the status indication portion of the row 324A-N to reveal, expose, or otherwise shown the pop-up window 408.

The pop-up window 408 may overlay at least a portion of the participant status interface/area 320 or be displayed separately from and adjacent to the participant status interface/area 320. In some embodiments, the pop-up window 408 may include information that is substantially similar, if not identical to, the information associated with presented content, slide thumbnails 332A-N, and/or representative frames transmitted to participant communication devices 108. In one embodiment, the information displayed in pop-up window 408 corresponds to a visual representation of the last successfully-transmitted, and received, frame by a particular communication device 108 in the list of participants 324A-N. By way of example, the pop-up window 408 in FIG. 4A illustrates that the participant communication device 108 associated with the participant (e.g., Jane) in the second row 324B is viewing the same content as being displayed in the presentation slide 316 of FIG. 3, represented by second slide thumbnail 332B. In this example, Jane is “in sync” with the presentation.

As shown in FIG. 4B, the user interface element 404 is hovering over, or selecting, the status associated with the third row 324C participant device. In one embodiment, as the user (e.g., presenter, moderator, etc.) moves the interface element 404 over the status indication portion of a particular row 324A-N a pop-up window 412, or thumbnail image may display to an area of the user interface 300. In some embodiments, the user may be required to hover over the status indication portion for a specific period of time, or actively select the status indication portion of the row 324A-N to reveal, expose, or otherwise shown the pop-up window 408. The pop-up window 412 of FIG. 4B shows that the participant communication device 108 associated with the participant (e.g., Richard) in the third row 324C is viewing content that was previously displayed in the presentation. In other words, the communication device 108 of Richard has yet to update (or catch up) and present the information being displayed in the presentation slide 316 of FIG. 3. Rather, the pop-up window of FIG. 4B shows that Richard is one slide behind the current slide of the presentation (e.g., Richard is viewing the first slide thumbnail 332A in the slide deck shown in FIG. 3). In generating the pop-up window 412, the user (e.g., presenter, moderator, etc.) can quickly determine where Richard is in the presentation. As indicated by the status indicator, and shown in the pop-up window 412, Richard is “out of sync” (e.g., updating, etc.) with the presentation.

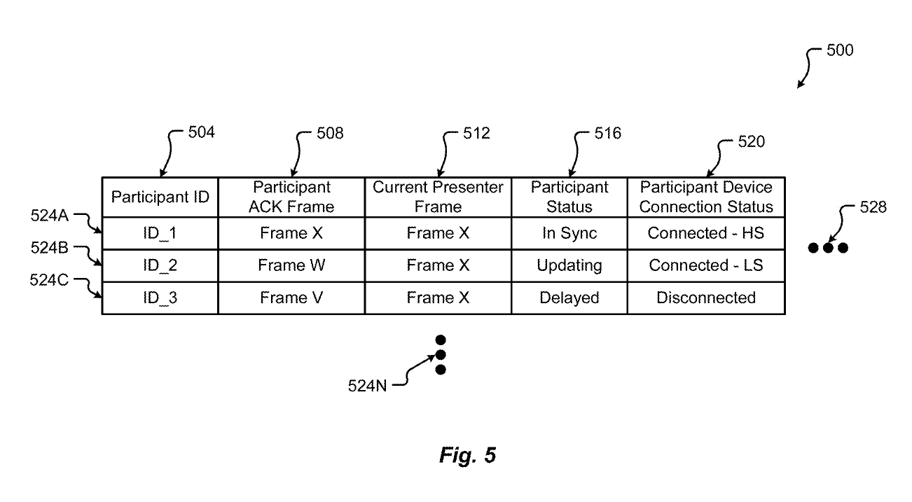

Referring to FIG. 5, a block diagram depicting a collaborative communication session participant device status data structure 500 will be described in accordance with at least some embodiments of the present disclosure. The data structure 500 may include a number of fields that may be used in the processes outlined herein. For instance, it is anticipated that the data structure 500 shown may be associated with one or more participant device status method performed by at least one communication management server 112. In particular, the data structure 500 depicted includes a plurality of data fields that contribute, at least in part, to the process of sharing participant device status. Examples of such data fields include, without limitation, a participant identification (“ID”) field 504, a participant acknowledgement (ACK) frame field 508, a current presenter frame field 512, a participant device status field 516, a participant device connection status field 520, and more 528.

The participant ID field 504 may comprise data used to identify or describe a particular participant and/or participant communication device 108 that is, or was, included in a collaborative communication session. This identification may be a name, phrase, word, symbol, number, character, and/or combination thereof. In some embodiments, the participant ID may correspond to a particular device ID, MAC address, IP address, hardware identification, etc., and/or combinations thereof. In some embodiments, the participant ID field 504 may be used to one or more of order, rank, differentiate, or assign importance to a particular communication device associated with a particular user 524A-N.

The participant ACK frame field 508 may comprise data used to identify a frame (e.g., presentation information, content, etc.) that was last successfully received by a particular participant communication device 108, or acknowledged as being successfully transmitted to the particular participant communication device 108. For instance, if a presenter is currently displaying information associated with Frame X in a presentation and a participant ACK frame indicates “Frame X” then the participant is “in sync” with the presentation. Conversely, if a participant ACK frame indicates “Frame W” then the participant is “out of sync” with the presentation, where the presenter is currently displaying information associated with Frame X in the presentation.

The current presenter frame field 512 may comprise data used to identify a frame that is being displayed by a presenter in a presentation. As provided above, the frame may be a particular image or combination of images associated with the presentation content. In some embodiments, as a presentation is in progress frames may be created to represent particular images or portions of the presentation. Among other things, comparison of a current presenter frame with a participant ACK frame can provide a quick evaluation of whether a participant device is in sync with a presentation, quickly illustrate a position of the participant communication device 108 in the presentation, indicate delays in transmission to a particular participant communication device 108, and/or signal to a presenter to adjust a pace of presentation. In any event, the synchronization status of a particular participant may be stored in a participant status field 516. The status may include, but is in no way limited to, “in sync” when the participant and the presenter are synchronized (e.g., viewing the same content, etc.), “updating” when the participant and the presenter are not synchronized but information is being transferred, “delayed” when the participant and the presenter are not synchronized and the participant is either disconnected from a communication session or transmission of frames has been significantly slowed.

The participant device connection status field 520 may comprise data used to identify information associated with a connection of a participant communication device 108 with the communication management server 112. The participant device connection status field 520 may comprise connection information which can include, but is in no way limited to, bandwidth, QoS, information upload rate, information download rate, ping statistics, reliability of a connection, “traceroute” or network transit delay information, etc., and/or combinations thereof. It is an aspect of the present disclosure that the connection monitor 124 may store connection information associated with one or more participant devices, presenter devices, and/or moderator devices (e.g., communication devices 108, 110, 128) at one or more times in the participant device connection status field 520.

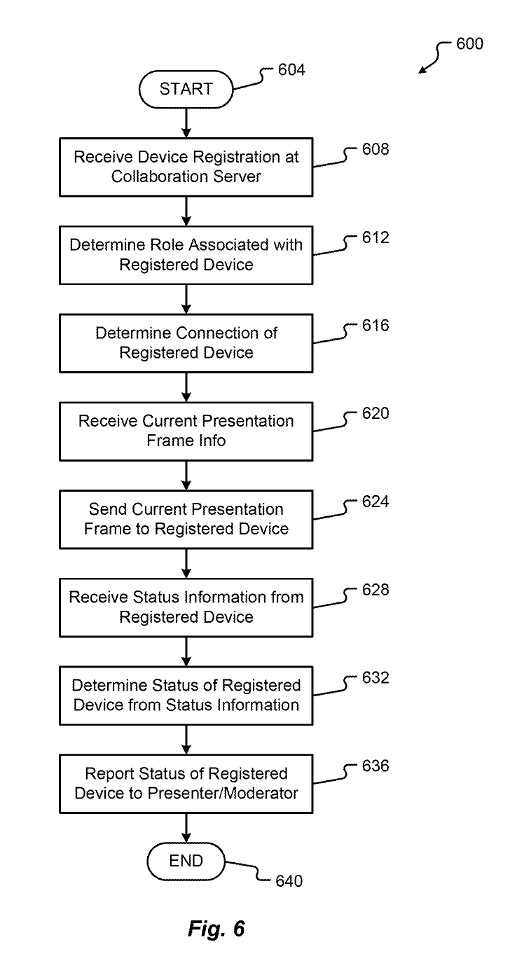

With reference to FIG. 6, a method 600 of automatically sharing participant device status in a collaborative communication session will be described in accordance with at least some embodiments of the present disclosure. The method 600 can be executed as a set of computer-executable instructions executed by a computer system and encoded or stored on a computer readable medium. Hereinafter, the method 600 shall be explained with reference to the systems, components, modules, applications, software, data structures, user interfaces, etc. described in conjunction with FIGS. 1-5. The method 600 begins at step 604 and proceeds when a communication device 108, 110, 128 registers with the collaboration or communication management server 112 (step 608). Registration may include a communication device 108, 110, 128 joining a collaborative communication session via a web browser, providing a device ID, participant ID, registration information, and/or other session information.

In some embodiments, the method 600 may proceed by determining the role of a participant associated with the registered communication device 108, 110, 128 (step 612). The role may be included as part of a registration procedure, stored in a memory, and/or associated with a company organization or hierarchical chart. In some cases, the communication management server 112 may refer to one or more memory locations to determine a role associated with a particular communication device 108 having a known participant device ID.

In some embodiments, the method 600 may determine connection information associated with the registered communication device in the collaborative communication session (step 616). As provided above, the connection information may include, but is in no way limited to, bandwidth, QoS, information upload rate, information download rate, ping statistics, reliability of a connection, “traceroute” or network transit delay information, etc., and/or combinations thereof.

The method 600 continues by receiving current presentation frame information from a presenter (step 620). The current presentation frame information may correspond to a representative image, or group of images, representing information displayed or shared in the collaborative communication session. This frame information may then be sent by the communication management server 112 to one or more participant communication devices 108 registered in the collaborative communication session. As described herein the frame information may be sent as part of a reliable transfer protocol. For example, the frame information may be sent using TCP/IP or other protocol utilizing send/receive acknowledgement. The method 600 may receive status information from the one or more registered communication devices 108 (step 628). This status information may include an ACK signal when the frame has been successfully transmitted across the communication network 104 to a communication device 108. In some embodiments, failure to receive an ACK signal may result in a timeout may occur, or an undeliverable content signal may be sent to the communication management server 112. This failure may serve as a status information for the registered communication device 108. In any event, each last successfully-transmitted frame for each communication device 108 is stored in memory and associated with the participant communication device 108.

Next, the method 600 determines a status of each registered communication device 108 based on the current presentation frame and the last successfully-transmitted frame for each registered communication device 108 (step 632). This determination may be made by automatically comparing the current presentation frame to the last successfully-transmitted frame for each registered communication device 108. When there is a mismatch, the status of the registered communication device associated with the mismatch may be listed as “out of sync.” Additionally or alternatively, the determination may include determining where in a set of frames a particular mismatching frame of a registered communication device 108 is in comparison to the current frame (e.g., ahead of, behind of, at a particular location relative to the current frame, etc.).

Upon determining the status of each registered communication device 108, the communication management server 108 may report the status of each registered communication device 108 to a presenter and/or moderator (step 636). Reporting the status may include listing a particular communication device 108 associated with a particular user and listing the synchronization status in a displayed field. The status may be similar, if not identical, to the “status” shown in the various user interfaces of FIGS. 3, 4A, and 4B. In some embodiments, the reported status may include frame information illustrating a position in the presentation that a particular communication device 108 is viewing. The method 600 ends at step 640.

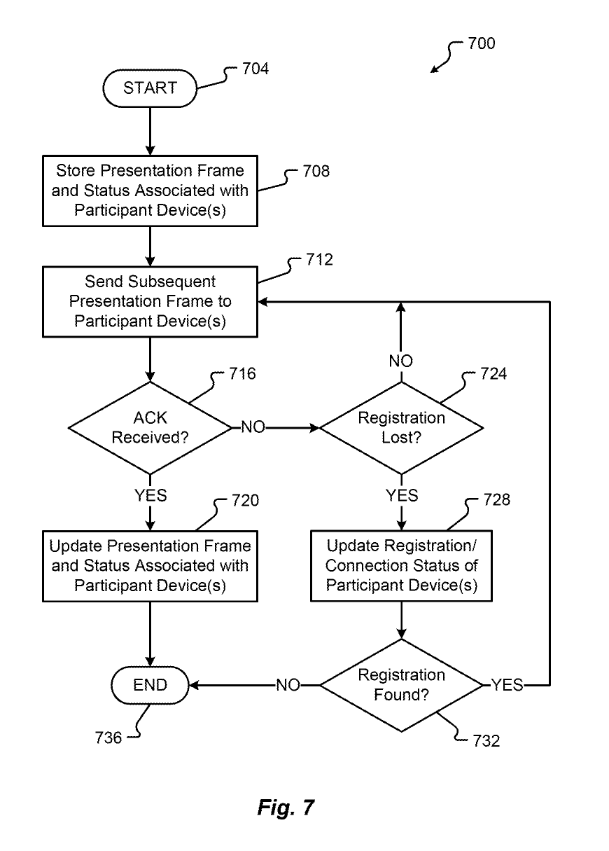

FIG. 7 shows a method 700 of automatically sharing participant device status in a collaborative communication session in accordance with at least some embodiments of the present disclosure. The method 700 can be executed as a set of computer-executable instructions executed by a computer system and encoded or stored on a computer readable medium. Hereinafter, the method 700 shall be explained with reference to the systems, components, modules, applications, software, data structures, user interfaces, etc. described in conjunction with FIGS. 1-6. The method 700 begins at step 704 and proceeds by storing a presentation frame and status associated with one or more communication devices 108, 110, 128 in a collaborative communication session (step 708). The presentation frame may correspond to the last successfully-transmitted, or received, frame associated with a particular communication device 108, 110, 128. The status may correspond to the status described above. For instance, the status may include a status of the particular communication device 108 relative to a presentation status of a presenting communication device 110.

The method 700 continues by sending a subsequent presentation frame, or frames, to the participant communication devices 108 in the collaborative communication session (step 712). The subsequent presentation frame may correspond to a current image, or group of images, representing information currently displayed or shared in the collaborative communication session by a presenter communication device 110. This frame information may then be sent by the communication management server 112 to one or more participant communication devices 108 in the collaborative communication session. As described herein the frame information may be sent as part of a reliable transfer protocol. For example, the frame information may be sent using TCP/IP or other protocol utilizing send/receive acknowledgement.

Next, the method 700 may determine whether an ACK signal, or acknowledgement signal, of the reliable transfer protocol is received from one or more of the participant communication devices 108 (step 716). The ACK signal may be received when the subsequent frame has been successfully transmitted across the communication network 104 to a participant communication device 108. In some embodiments, failure to receive an ACK signal may result in a timeout may occur, or an undeliverable content signal may be sent to the communication management server 112.

In the event that the ACK is received, the method 700 may update a stored presentation frame and status associated with the participant communication device 108 (step 720). This update may include altering a presentation of information regarding the participant communication device 108 rendered to a display of the presenter communication device 110 and/or the moderator communication device 128. For instance, the update may include altering the data structure 500 described in conjunction with FIG. 5 and/or a status indicator rendered to a user interface as described in conjunction with FIGS. 3, 4A, and 4B

If no ACK is received, the method 700 may continue by determining whether a registration or connection between the communication management server 112 and a particular participant communication device 108 was lost (step 724). If not, the method 700 may return to step 712 and resend the presentation frame. However, if the registration is lost, the method 700 may proceed to update a registration and/or connection status of the participant communication device 108 that failed to return the ACK signal (step 728). This update may include altering the data structure 500 described in conjunction with FIG. 5 and/or a status indicator rendered to a user interface as described in conjunction with FIGS. 3, 4A, and 4B.

In some embodiments, the method 700 may determine whether the communication device 108 has reregistered and/or reconnected to the communication management server 112 (step 732). If not, the method 700 ends at step 736. However, if the communication device 108 has reregistered and/or reconnected to the communication management server 112, the method 700 may return to step 712 and resend the subsequent frame that was not received by the communication device 108. It should be appreciated, that the method 700 may be performed simultaneously for multiple communication devices 108 in a collaborative communication session.

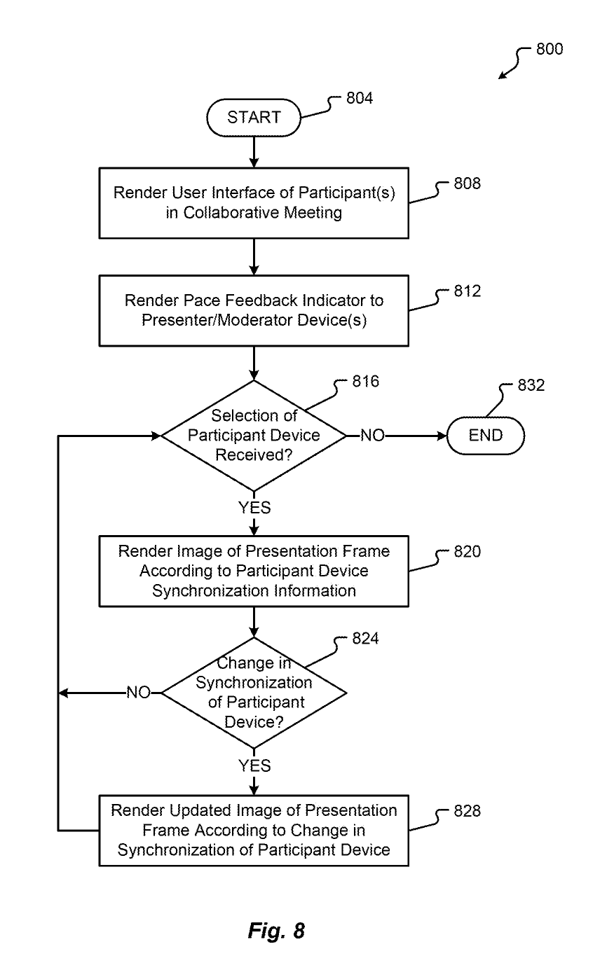

FIG. 8 shows a method 800 of sharing participant device status and frame information in a collaborative communication session in accordance with at least some embodiments of the present disclosure. The method 800 can be executed as a set of computer-executable instructions executed by a computer system and encoded or stored on a computer readable medium. Hereinafter, the method 800 shall be explained with reference to the systems, components, modules, applications, software, data structures, user interfaces, etc. described in conjunction with FIGS. 1-7. The method 800 begins at step 804 and proceeds by rendering a user interface 300, 320 including participants and associated devices in a collaborative communication session (step 808).

In some embodiments, the method 800 may render a pace feedback indicator 340 to the user interface 300 (step 812). The pace feedback indicator 340 may include information regarding a pace of the presentation that is based, at least partially, on a synchronization status of one or more participant communication devices 108 in the collaborative communication session. For instance, the pace feedback indicator 340 may include an indication of whether a particular participant device is delayed. In one embodiment, the pace feedback indicator 340 may include a notification or particular indicator configured to alert the presenter that an adjustment in pace is necessary based, at least in part, on the transmission of information to one or more of the participant communication devices 108. These indicators and/or notifications are described in greater detail in conjunction with FIG. 3.

The method 800 may proceed when an icon or a rendered element representing a particular communication device 108 is selected for a detailed status inquiry (step 816). The selection may include moving a user interface element 404 (e.g., mouse cursor, etc.) over, or selecting, a particular participant, or portion thereof, that is rendered in the user interface (e.g., as a row 324A-B, icon, name, status, etc.). In some embodiments, a presenter, moderator, or other user may be required to hover the user interface element 404 over a portion of a particular participant device for a specific period of time, or actively select the portion of the row 324A-N to reveal, expose, or otherwise show a pop-up window 408, 412 illustrating content that is being viewed by the selected device.

In the event that an icon or a rendered element representing a particular communication device 108 is selected for a detailed status inquiry, the method 800 continues by rendering an image of a frame that was last successfully-transmitted to the particular communication device (step 820). This image may be rendered as a pop-up, thumbnail, or other image. In one embodiment, the content displayed in image or pop-up window may correspond to a visual representation of the last successfully-transmitted, and received, frame by a particular communication device 108.

Next, the method 800 determines whether there is any change to the synchronization of the particular communication device 108 with the communication management server 112 (step 824). For instance, the method 800 may determine whether a different frame has been successfully-transmitted to the particular communication device 108. As can be appreciated, multiple frames may be transmitted to connected communication devices 108 during a presentation of a collaborative communication session. As each new frame is successfully transmitted to a particular communication device 108, the particular communication device 108 may view new content associated with the presentation. In the event that a synchronization change is determined, the method 800 proceeds by rendering an updated image of the frame that was last successfully-transmitted to the particular communication device (step 828). As described above, the image may be rendered as a pop-up, thumbnail, or other image. The method 800 may repeat and continue until no further synchronization changes are determined and/or no selection of a participant device is received. The method 800 ends at step 832.

Any of the steps, functions, and operations discussed herein can be performed continuously and automatically.

The exemplary systems and methods of this disclosure have been described in relation to conferences and communication systems. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

What is claimed is:

1. A communication system, comprising:
a server, comprising:
a microprocessor; and
a computer readable medium coupled to the microprocessor and comprising instructions stored thereon that cause the microprocessor to:
produce instructions that render a participant device status window in a user interface, the participant device status window including a presentation synchronization status for one or more participant devices in a collaborative communication session;
send a presentation frame to the one or more participant devices in the collaborative communication session when a presentation content associated with the collaborative communication session changes;
determine whether the one or more participant devices received the presentation frame sent;
update the presentation synchronization status for the one or more participant devices based on the determination of whether the one or more participant devices received the presentation frame sent; and
present the presentation synchronization status for the one or more participant devices to a presenter device in the collaborative communication session.

2. The communication system of claim 1, wherein the presentation synchronization status comprises a synchronization identifier and a representative image, the synchronization identifier indicating a synchronization type for the one or more participant devices and the representative image corresponding to an image of a last presentation frame received by the one or more participant devices.

3. The communication system of claim 2, wherein the presentation synchronization status for each participant device of the one or more participant devices in the participant device status window is configured to receive a selection input, and wherein the selection input causes a thumbnail of the image of the last presentation frame received by the one or more participant devices to be rendered by a display of the presenter device.

4. The communication system of claim 2, wherein prior to causing the microprocessor to send the presentation frame to the one or more participant devices in the collaborative communication session, the microprocessor is caused to:
receive presentation content information from the presenter device; and
convert the received presentation content into the presentation frame.

5. The communication system of claim 2, wherein the presentation frame is sent with a receipt acknowledgement request, and wherein causing the microprocessor to determine whether the one or more participant devices received the presentation frame sent further causes the microprocessor to determine whether a receipt acknowledgement is received from the one or more participant devices.

6. The communication system of claim 2, wherein causing the microprocessor to update the presentation synchronization status further causes the microprocessor to:
determine whether the synchronization identifier should be updated, wherein the synchronization identifier should be updated only when the one or more participant devices did not receive the presentation frame sent; and
determine whether the representative image should be updated, wherein the representative image should be updated only when the one or more participant devices received the presentation frame sent.

7. The communication system of claim 2, wherein the presentation frame is sent to the one or more participant devices using a reliable data transfer protocol, the reliable data transfer protocol requiring the one or more participant devices to send an acknowledgement signal when the presentation frame is received by the one or more participant devices.

8. The communication system of claim 2, wherein the collaborative communication session is hosted by the server.

9. A method, comprising:
generating, via a processor, a participant device status window for rendering in a user interface, the participant device status window including a presentation synchronization status for one or more participant devices in a collaborative communication session;
sending, via the processor, a presentation frame to the one or more participant devices in the collaborative communication session when a presentation content associated with the collaborative communication session changes;
determining, via the processor, whether the one or more participant devices received the presentation frame sent; and
updating, via the processor, the presentation synchronization status for the one or more participant devices based on whether the one or more participant devices received the presentation frame sent.

10. The method of claim 9, wherein the presentation synchronization status comprises a synchronization identifier and a representative image, the synchronization identifier indicating a synchronization type for the one or more participant devices and the representative image corresponding to an image of a last presentation frame received by the one or more participant devices.

11. The method of claim 10, wherein the presentation synchronization status for each participant device of the one or more participant devices for rendering in the participant device status window is configured to receive a selection input, and wherein the selection input causes a thumbnail of the image of the last presentation frame received by the one or more participant devices to be rendered by a display device.

12. The method of claim 10, wherein prior to causing the microprocessor to send the presentation frame to the one or more participant devices in the collaborative communication session, the method further comprises:
receiving, via the processor, presentation content information from a presenter device in the collaborative communication session; and
converting, via the processor, the received presentation content into the presentation frame.

13. The method of claim 10, wherein the presentation frame is sent with a receipt acknowledgement request, and wherein determining whether the one or more participant devices received the presentation frame sent further comprises determining whether a receipt acknowledgement is received from the one or more participant devices.

14. The method of claim 10, wherein updating the presentation synchronization status further comprises:
determining, via the processor, whether the synchronization identifier should be updated, wherein the synchronization identifier should be updated only when the one or more participant devices did not receive the presentation frame sent; and
determining, via the processor, whether the representative image should be updated, wherein the representative image should be updated only when the one or more participant devices received the presentation frame sent.

15. The method of claim 10, wherein the presentation frame is sent to the one or more participant devices using a reliable data transfer protocol, the reliable data transfer protocol requiring the one or more participant devices to send an acknowledgement signal when the presentation frame is received by the one or more participant devices.

16. The method of claim 9, further comprising:
presenting, via the processor, the presentation synchronization status for the one or more participant devices to a presenter device in the collaborative communication session.

17. The method of claim 16, wherein the presentation synchronization status comprises presentation pace feedback information configured to be rendered as an indication that the presenter device is moving at least one of too quickly, too slowly, or sufficiently through a presentation in the collaborative communication session.

18. A conference server, comprising:
a processor; and
a computer-readable medium, coupled with the processor, the computer-readable medium comprising instruction sets that are executable by the processor, wherein the instruction sets cause the processor to:
receive a presentation frame from a presenter device in a collaborative communication session with one or more participant devices when a presentation content associated with the collaborative communication session changes;
send the presentation frame to the one or more participant devices in the collaborative communication session;
receive an acknowledgement message from each participant device in the one or more participant devices that received the presentation frame sent; and
determine a presentation synchronization status for the one or more participant devices in the collaborative communication session identifying a state of synchronization for each of the one or more participant devices in the collaborative communication session, wherein a participant device in the one or more participant devices is identified as being out of synchronization when no acknowledgement message is received from the participant device.

19. The conference server of claim 18, wherein the presentation synchronization status is included in a participant device status window presented to the presenter device in the collaborative communication session.

20. The conference server of claim 19, wherein the presentation synchronization status comprises a synchronization identifier and a representative image, the synchronization identifier indicating a synchronization type for each of the one or more participant devices and the representative image corresponding to an image of a last presentation frame received by each of the one or more participant devices, wherein the presentation synchronization status for each of the one or more participant devices in the participant device status window is configured to receive a selection input, and wherein the selection input causes a thumbnail of the image of the last presentation frame received by the one or more participant devices to be rendered by a display of the presenter device.
